(19) United States
(12) Patent Application Publication
(10) Pub. No.: US 2011/0021087 A1
(43) Pub. Date: Jan. 27, 2011

(54) PLASTIC HOUSING HAVING INTEGRATED PLUG INTERFACE

(76) Inventors: Marc Koltermann, Stuttgart (DE); Reinhold Herrmann, Stuttgart (DE)

Correspondence Address: KENYON & KENYON LLP, ONE BROADWAY, NEW YORK, NY, 10004, US

(21) Appl. No.: 12/735,288

(22) PCT Filed: Dec. 5, 2008
(86) PCT No.: PCT/EP2008/066860

§ 371 Date: Oct. 1, 2010

(30) Foreign Application Priority Data
Jan. 10, 2008 (DE) 10 2008 003 848.2

(51) Int. Cl. H01R 13/502; B23P 17/00

(52) U.S. Cl. 439/701; 29/527.1

(57) ABSTRACT

A plastic housing having an integrated plug interface with a plastic housing, in which at least one electrically contacted plug pin is held, wherein the at least one plug pin is held in an embedment in the plastic housing and is electrically contacted by contacts of a plug housing. The plug housing and the plastic housing are produced as separate components. They are connected to each other by a material connection.

### FIELD OF THE INVENTION

The present invention relates to a plastic housing having an integrated plug interface and a method relating thereto.

### BACKGROUND INFORMATION

German patent document DE 197 31 420 A1 discusses a device for pressure measurement. The device described there is used to measure the pressure in the intake manifold of an internal combustion engine and has a carrier designed as a hybrid plate situated in a housing. A first housing space, provided as a pressure space, in which a sensor element situated on the carrier is located, is connectable via a pressure connection to the intake manifold and is sealed off from its surroundings which includes a second housing space using an adhesive. Bond wires, which electrically connect the carrier to a plug part, are situated in the second housing space, which is provided as a bond space.

German patent document DE 102 23 357 A1 discusses a device for pressure measurement. It has a housing in which a carrier provided with a sensor element and with electrical terminal elements is situated. The housing has a first housing space surrounding the sensor element and connected to a first pressure channel of a first pressure connection and has a second housing space, which surrounds at least the electrical terminal elements and is sealed with respect to the first housing space. The housing additionally has a third housing space, which is sealed with respect to the first housing space and the second housing space and is connected to a second pressure channel of a second pressure connection.

The pressure sensor housings used today such as sensor housings for pressure sensors are usually injection-molded plastic parts. This means that the sensor housing and a plug housing, together with plug pins, are injected into a plastic mold. The plug housings are high-precision parts, which make high demands on the precision of the pressure sensor housing to be injection molded in one operation, i.e., the sensor housing and the plug housing. As a result, the sensor housing is necessarily also manufactured with high standards regarding its tolerance, even though this is not required. Furthermore, in manufacturing pressure sensors, the finished housing, including the plug housing and sensor housing, passes through a curing oven. The plastics are cured inside the curing oven; this is associated with thermal deformation, which has a negative effect on the plug dimensions, which had previously been strictly accurate. This deformation necessarily occurs in passing through the curing oven and is difficult to prevent in the case of relatively large sensor housings having integrally molded plug housings in particular. Moreover, flexibility is also very limited because a separate sensor housing and a separate injection mold required for same must be manufactured and kept on hand for almost each customer's plug.

### SUMMARY OF THE INVENTION

An object of the exemplary embodiments and/or exemplary methods of the present invention is to provide a housing having an integrated interface, which is manufactured by the plastic injection molding method and has a much greater flexibility with regard to customer's plug variants and makes lower demands regarding the precision of the mold in which the plastic housing is manufactured.

The plastic housing may be a housing in which a sensor is accommodated or a housing which holds an actuator for actuating a final controlling element, or the like.

It is proposed according to the exemplary embodiments and/or exemplary methods of the present invention that a plug interface for contacting a sensor or an actuator be manufactured separately from the plastic housing in which the sensor or actuator contacting the plug interface is accommodated. The plug interface may be welded to the plastic housing forming the base part in a subsequent operation, for example, by the plastic laser welding method. This allows the use of an injection mold having a simpler design for manufacturing the plastic housing and a mold of a simpler design for fabrication of the particular plug interface.

The approach proposed according to the exemplary embodiments and/or exemplary methods of the present invention increases flexibility due to the possibility of using the customer's particular plug interface variant, i.e., the injection mold required for manufacturing same, so that a shared mold may still be used for fabrication of the plastic housing. The plug pins may be replaced by replaceable inserts in the mold. With regard to the fabrication of the plastic housing and the plug interface, which is fabricated separately from the former, cost savings may be achieved due to the fact that it is not absolutely necessary to use a separate injection mold for each variant of a plastic housing.

The approach proposed according to the exemplary embodiments and/or exemplary methods of the present invention allows greater flexibility with regard to the variants of plug interfaces demanded by customers while retaining a housing mold for manufacturing a plastic housing for a sensor or an actuator which is usable for multiple variants. The mold for manufacturing the plug interfaces may have a simpler design, in particular without insertion parts which are usually fabricated from a metallic material and are used to manufacture the plug pins. In comparison with the precision requirements which are made for the plug interface, i.e., the housing, and are necessary to achieve dimensionally more stable plug interfaces, relatively low precision requirements may be made for the mold in comparison with that by fabricating the plastic housing to receive the sensor or the actuator. In addition, when using the approach proposed according to the present invention, redundancy is achieved in sealing the plug pins in the interior of the sensor housing.

Thus, following the approach proposed according to the exemplary embodiments and/or exemplary methods of the present invention, the plastic housing for holding a sensor or an actuator is manufactured in the housing mold using insert parts for fabrication of the plug pins by the plastic injection molding method. For each variant of a customer's plug interface, which is to be connected to the plastic housing, the customer's own plug pins are sheathed by using replaceable insertion parts. This is necessary because plug pins may have various thicknesses, shapes, patterns, surfaces, and materials, as a function of the customer's requirements.

Following the approach proposed according to the present invention, the plug interfaces are injected separately from the plastic housing and are manufactured with a high precision due to the simple mold shape. Due to the approach provided by the exemplary embodiments and/or exemplary methods of the present invention of the separate fabrication of the plastic housing to hold a sensor or an actuator and the plug housing, which is a customer-specific design of a plug interface, it is possible to achieve a simpler method of maintaining tolerances, in particular in the fabrication of the plug part, which is to be manufactured to a high precision, so that the plastic housing, which has lower tolerance requirements, may be fabricated to hold a sensor or an actuator of lower tolerance requirements and in particular one and the same injection mold may be used. The precision requirements made for the plug interface on the one hand and the plastic housing on the other hand may thus be uncoupled from one another with regard to the fabrication. Furthermore, the geometry in which the plastic housing is fabricated is simplified by separating the fabrication of the customer-specific design of the plug part forming the plug interface, so that smaller base bodies may be used and a fabrication that is more suitable for plastics is implementable.

The plug housing, which forms the plug interface and is fabricated separately, is attached to the plastic housing, which is fabricated separately and is pressed as far as a stop, for example. This means that the plug pins attached to the plastic housing are surrounded by the plug housing and may push through it. In assembly, the plug pins of the plastic housing for receiving a sensor or an actuator pass through the bottom face of the plug housing representing the plug interface. In pushing through the bottom surface of the plug housing, for example, the plug pins may be additionally sealed by displaced material at the particular passages. The plug housing may be bonded to the plastic housing on its lateral surface, for example, by laser welding along the circumference and thus joined mechanically to the plastic housing, which is manufactured separately and forms a basic module.

The plastic housing to receive a sensor or an actuator and the plug interface as proposed according to the present invention being designed as separate parts advantageously ensures that the plug pins embedded in the plastic housing, which forms a basic module, are sheathed in the plastic housing on the one hand while on the other hand they may be additionally sealed in the assembly of the plug housing by pushing through the bottom of the plug housing, so that there is redundant sealing of the plug pins.

The exemplary embodiments and/or exemplary methods of the present invention is described in greater detail below on the basis of the drawings on the example of a pressure sensor.

### BRIEF DESCRIPTION OF THE DRAWINGS

FIG. 1 shows a component made up of a plug part and a housing part designed in one piece.

FIG. 2 shows a section through the plug part of the sensor component designed in one piece according to the diagram in FIG. 1.

FIG. 3 shows a perspective top view of a separate plug housing representing a plug interface in a first embodiment variant, bonded to a plastic housing to receive a sensor.

FIG. 3.1 shows a section through the bonded connection between the plug housing in the first embodiment variant and the plastic housing as shown in FIG. 3.

FIG. 4.1 shows another embodiment variant of the plug housing.

FIG. 4.2 shows another variant of the plug housing.

FIG. 4.3 shows the plug housing in its first specific embodiment as shown in FIG. 3 in the materially joined state.

FIG. 4.4 shows a front view of the plastic housing to receive a sensor or an actuator having plug pins surrounded by a border for electrical contacting.

### DETAILED DESCRIPTION

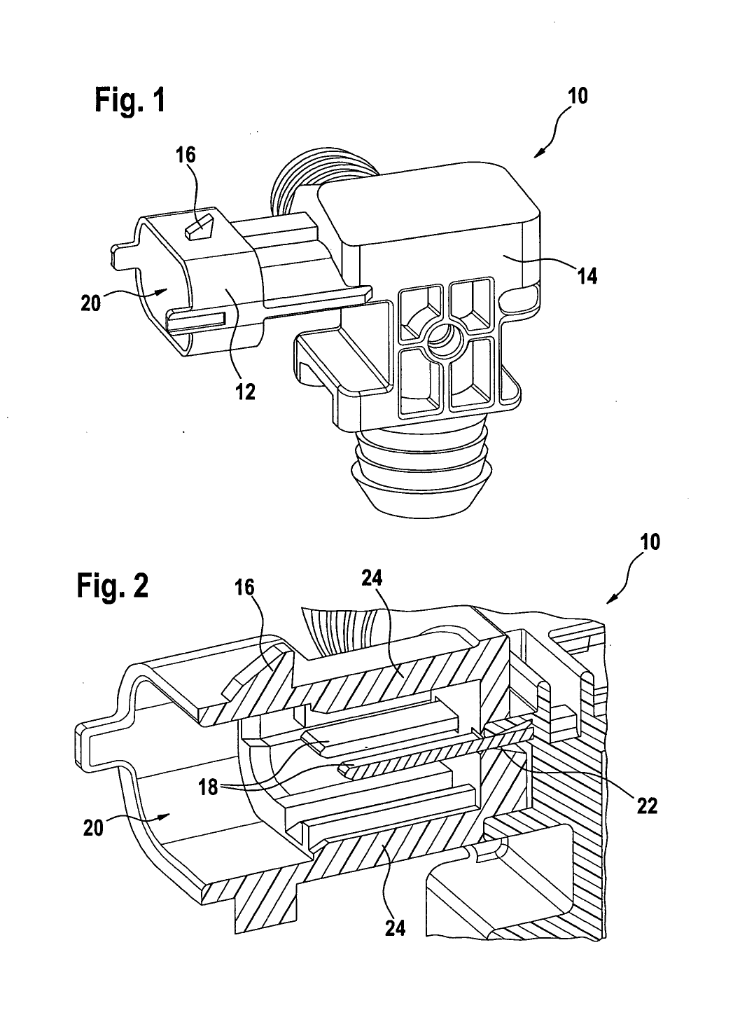

The diagram according to FIG. 1 shows a sensor component designed in one piece, as is known from the related art.

As shown by the perspective diagram according to FIG. 1, sensor component 10 designed in one piece as a plastic injection-molded component has a plug part 12 and a housing part 14, which are designed to merge into one another. A catch nose 16 is provided on plug part 12. Plug part 12 surrounds plug pins 18, which are discernible in the sectional diagram according to FIG. 2. The plug part of the sensor component designed in one piece according to the diagram in FIG. 1 includes a plug opening 20 into which a plug is inserted and on which catch nose 16 may be lockingly engaged.

FIG. 2 shows a sectional diagram through sensor component 10 according to the diagram in FIG. 1. FIG. 2 shows plug pins 18 embedded in the plastic material of sensor component 10. The embedding to receive plug pins 18 is labeled with reference numeral 22. Reference numeral 24 denotes the shared wall of housing part 14 and plug part 12 of sensor component 10, which is designed in one piece. The one-piece design of the sensor component in FIGS. 1 and 2 has the disadvantage that although plug part 12 is fabricated to relatively high precision requirements to receive the plug having a customer-specific design and initially has a high dimensional stability, it is subject to thermal deformation in a curing process in a curing oven. With respect to housing part 14 of sensor component 10, which is designed in one piece, the thermal deformation, which occurs during passage through the curing oven due to the higher temperatures prevailing there, is of subordinate importance; however, the thermal deformation has substantial effects with respect to plug part 12 of sensor component 10, which is designed in one piece, in particular with regard to the dimensional stability which has previously been established in a tedious operation. With regard to the fabrication of sensor component 10, which is designed in one piece according to the diagrams in FIGS. 1 and 2, it may be stated that the plastic injection mold, in which sensor component 10, which is designed in one piece, together with plug part 12 and housing part 14 is fabricated, is inflexible with regard to retrofitting to customer-specific differences in configuration of plug parts 12. Therefore, relatively high retrofitting and mold costs are unavoidable with respect to the injection mold used in the approach having a sensor component 10 designed in one piece.

### DETAILED DESCRIPTION OF THE INVENTION

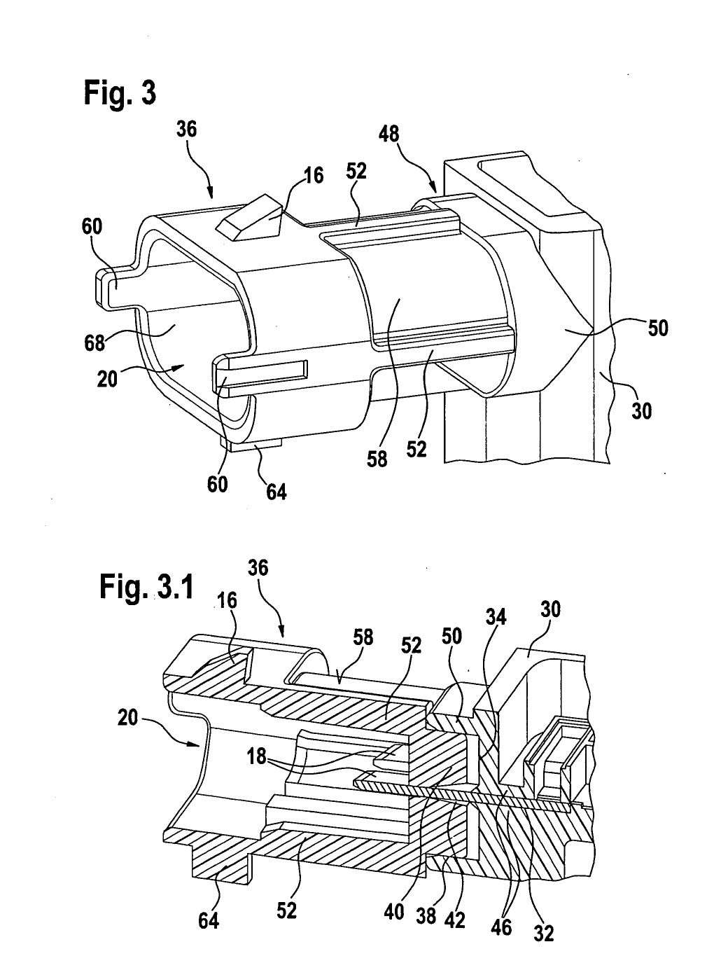

The diagrams in FIGS. 3 and 3.1 show plastic housings fabricated separately from one another and then joined together for a sensor or an actuator or a plug housing in a first embodiment variant.

FIG. 3 shows that a plug housing 36 in the first embodiment variant may have catch nose 16 on its top side and, if necessary, another lower catch engagement 64 on its bottom side. Reference numeral 60 denotes catch noses situated on the side. In the first embodiment variant, longitudinal ribs 72 run on a lateral surface 58 of plug housing 36. Longitudinal ribs 72 function as a guide for a mating plug, which is not shown in the diagram according to FIG. 3.

As also shown in the diagram according to FIG. 3, a border 50 is extruded on plastic housing 30 to receive a sensor or an actuator. Border 50 surrounds a receptacle opening 34, which is best shown in the sectional diagram according to FIG. 3.1. Although plug housing 36 in its first variant is fabricated in a separate injection mold to high precision requirements for the resulting injection-molded component, plastic housing 30 may be manufactured less expensively in an injection mold because the tolerances required are much lower due to the smaller and overall less complex geometry of the injection mold, in which plastic housing 30 is fabricated separately in comparison with the tolerances required of the fabrication of plug housing 36 as well as its further embodiment variants in an injection mold.

FIG. 3.1 shows a sectional diagram of the sectional components joined together according to FIG. 3, namely the plug housing in the first embodiment variant and the plastic housing to receive a sensor or an actuator.

FIG. 3.1 shows that plug housing 36 in the first embodiment variant is fitted into receptacle opening 34 of plastic housing 30. A fit which is established between a bottom part 40 of plug housing 36 in the first embodiment variant and the boundary of receptacle opening 34 is identified by reference numeral 38 in the sectional diagram according to FIG. 3.1.

FIG. 3.1 shows that plug pins 18 may be pushed through openings 42 in the bottom part of plug housing 36 when plug housing 36 is assembled in the first embodiment variant according to FIG. 3.1 in receptacle opening 34. In pushing through at least one opening 42 for at least one plug pin 18, which is accommodated in embedding 32 in plastic housing 30 to receive a sensor or an actuator, a seal 44 is formed around plug pins 18 passing through openings 42.

When plug pins 18 are optionally pushed through at least one opening 42 in bottom part 40 of plug housing 37 in the first specific embodiment, the plastic material bordering at least one opening 42 in bottom 40 is deformed and forms seal 44 around individual plug pins 18. The approach of manufacturing plastic housing 30 and plug housing 36 separately in different specific embodiments, as proposed according to the present invention and explained below, allows redundant sealing of plug pins 18, first in embedding 32 of plastic housing 30 and secondly in seal 44 in bottom part 40 of plug housing 36 in the first embodiment variant. The projecting portion by which the ends of plug pins 18 protrude above bottom part 40 through openings 42 may be adjusted through the design of the height of bottom part 40 of plastic housing 30 to receive an actuator or a sensor.

The sectional diagram in FIG. 3.1 shows a longitudinal rib 52, which assumes the function of a spacer for a mating plug. Damage to or bending of plug pins 18 when plug housing 36 is manufactured in receptacle opening 34, bordered by border 50, of plastic housing 30 to receive a sensor or an actuator is/are prevented by at least one longitudinal rib 52, which is formed on lateral surface 58 of plug housing 36 in its first specific embodiment.

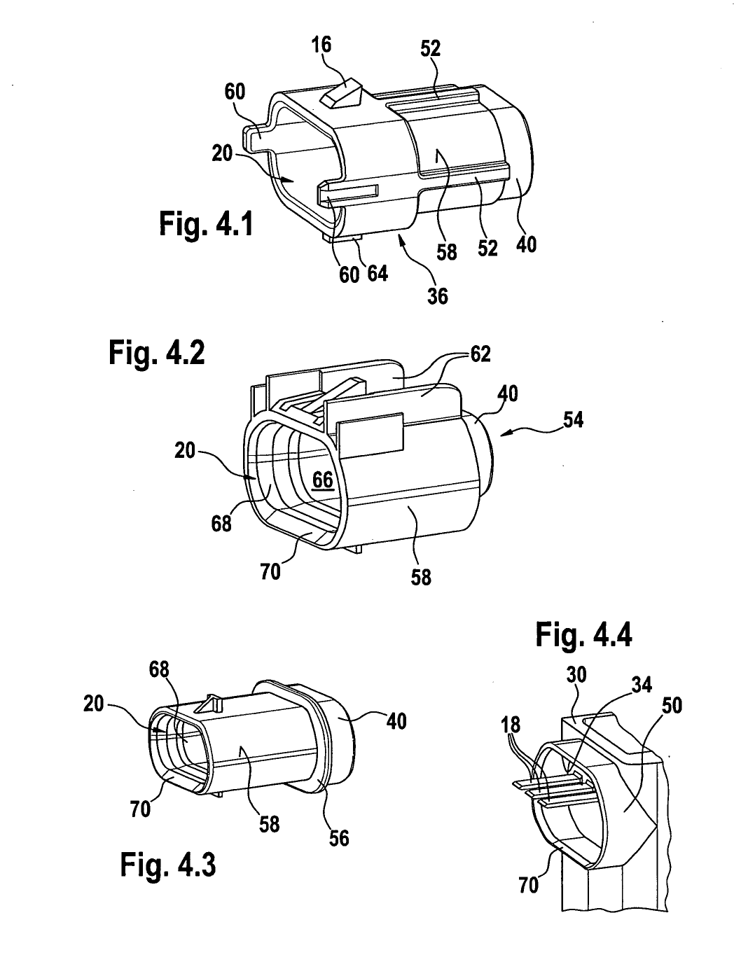

The sequence of FIGS. 4.1, 4.2, and 4.3 shows, as an example, various embodiment variants of the plug housing to be fabricated separately from the plastic housing to receive a sensor or an actuator, as proposed according to the present invention.

FIG. 4.1 shows the plug housing in a first specific embodiment 36 having catch nose 16 and lower catch engagement 64 opposite the former. Plug opening 20 may optionally be provided with a tapered edge 70 to allow easier insertion of the electrical plug, which has been finished according to customer-specific requirements. As also shown in the perspective diagram in FIG. 4.1, at least one longitudinal rib 52 runs on lateral surface 58 of plug housing 36 in the first embodiment variant. Longitudinal rib 52 extends for a defined length on lateral surface 58. Two, four, or more, longitudinal ribs 52 may be provided on lateral surface 58 of plug housing 36 in the first embodiment variant. In third embodiment variant 72 of the plug housing shown in FIG. 4.3, peripheral collar 56 has the function of limiting the depth of immersion. In the embodiment variant of plug housing 54 shown in FIG. 4.2, the depth of insertion of bottom part 40 of the plug housing in second specific embodiment 54 is defined by the axial length of bottom part 40 and the shoulder adjacent thereto in lateral surface 48 of the plug housing in second embodiment variant 54.

FIG. 4.2 shows another possible specific embodiment of the plug housing, shown here in a second embodiment variant.

FIG. 4.2 shows plug housing 54 in a second specific embodiment. This customer-specific embodiment of plug housing 54 is injected in a plastic injection mold, thus ensuring a high dimensional stability by the single- or two-component injection molding method. Numerous guide ribs 62 extending axially to lateral surface 58 of plug housing 54 in the second embodiment variant are provided on lateral surface 58 of plug housing 54 in the second specific embodiment. In addition, catch nose 16 is situated between ribs 62. If necessary, a tapered edge 70 may be provided on the border of plug opening 20, allowing simple insertion of the customer-specific plug into plug opening 20, which is delimited by inside wall 68. A hollow space 66, which is surrounded by inside wall 68 of plug housing 54 in the second embodiment variant, is much larger in comparison with the third embodiment variant of plug housing 72 shown in FIG. 4.3.

Bottom part 40, which is inserted into receptacle opening 34 of sensor housing 30 shown in FIG. 3.1 in a sectional view and in a perspective top view in FIG. 4.4, is extruded onto an end face of the plug housing in second specific embodiment 54.

FIG. 4.3 shows a possible third variant of plug housing 72, which has a peripheral collar 56 in addition to catch nose 16 and a lower catch 64 situated opposite the former on lateral surface 58. Peripheral collar 56 determines the depth of immersion by which the bottom part of plug housing 72 in the third specific embodiment is inserted into receptacle opening 34 of plastic housing 30 to receive a sensor or an actuator, shown in a sectional view in FIG. 3.1. Reference numeral 68 refers to an inside wall of plug housing 72 in the third embodiment variant. A customer-specific plug designed to be complementary to the particular specific embodiment of plug housing 72 is inserted into plug opening 20. This establishes electrical contact with plug pins 18 surrounded by lateral surface 58 of plug housing 72 in the third specific embodiment.

FIG. 4.4 shows a perspective view of the plastic housing, which is fabricated separately from the plug housing for receiving a sensor or an actuator.

FIG. 4.4 shows that receptacle opening 34 is surrounded by border 50. According to the perspective top view in FIG. 4.4, three plug pins 18 situated side by side are embedded in the material of plastic housing 30 to receive a sensor or an actuator. Embedding 32 is best shown in the sectional diagram in FIG. 3.1. To facilitate assembly of bottom part 40 of each specific embodiment of plug housing 36, 54, 72, which is fabricated separately, in receptacle opening 34 of plastic housing 30, a tapered edge 70 is provided on border 50 of receptacle opening 34, facilitating tilt-free insertion of bottom part 40 and ensuring undamaged insertion, i.e., pushing of plug pins 18 through at least one opening 42 in bottom part 40 of plug housing 36, 54, 72 in its various specific embodiments.

Plastic housing 30 according to the diagrams in FIGS. 3 and 4 is fabricated together with the insertion of plug pins 18 into the injection mold to manufacture plastic housing 30. For each customer-specific plug variant, separate plug pins 18 must also be sheathed by a replaceable insert (insertion part). Customer-specific plug pins 18 have variable thicknesses, shapes, patterns, surfaces, and materials. Plug housings 36, 54, 72 in the specific embodiments are plug interfaces, which are fabricated separately in separate molds by the injection molding method and may be manufactured to a high precision by using a smaller and simpler mold, regardless of the lower tolerance requirements of plastic housing 30 to receive the sensor or the actuator. The dimensional stability requirements to be made for plug housings 36, 54, and 72 in the various embodiment variants are much higher in comparison with the mold used for manufacturing plastic housing 30. When plug housings 36, 54, and 72, which form the plug interface in the various embodiment variants are assembled, the plug housings are attached to plastic housing 30 to receive an actuator or a sensor and are pressed into receptacle opening 34. Plug pins 18 are additionally sealed by pressure on their openings 42 (cf. reference numeral 44 in the sectional diagram according to FIG. 3.1). Plug housing 36, 54, 72, which forms the customer-specific plug interface, is bonded to plastic housing 30 to receive a sensor or an actuator, i.e., its border 50 (cf. item 48 in FIG. 3). There is thus a mechanical connection between plug housing 36, 54, 72, which forms the plug interface, and plastic housing 30, which forms the basic module.

The approach of manufacturing plug housing 36, 54, 72 independently of plastic housing 30 to receive a sensor or an actuator, as proposed according to the present invention, allows greater flexibility in customer variants, in particular in the case of plug geometries of various designs. Plastic housing 30 of the same design may ideally always be used. The approach proposed according to the present invention results in injection molds of a smaller and simpler design and a higher precision in manufacturing the plug interfaces formed by the various sensor housing variants.

Although the requirements of plastic housing 30, which always has essentially the same design, to receive a sensor or an actuator always remain the same, the more complex plug geometries for plug housings 36, 54, and 72 may be constructed in separate but smaller molds as a function of customer specifications. Much greater tolerance demands are made for these customer-specific designs for the injection molds for manufacturing plug housings 36, 54, and 72 in comparison with the requirements for the mold for manufacturing plastic housing 30 to receive the sensor or the actuator.

1-10. (canceled)

11. A plastic housing, comprising:
an integrated plug interface; and
at least one plug pin to be contacted electrically, the at least one plug pin being accommodated in an embedding in the plastic housing and electrically contacted by contacts of a plug housing;
wherein the plug housing and the plastic housing are fabricated as separate components and are connected to each other by a material connection.

12. The plastic housing of claim 11, wherein the at least one plug pin protrudes out of the plastic housing into a receptacle opening, which is delimited by a border.

13. The plastic housing of claim 12, wherein the border has a tapered edge.

14. The plastic housing of claim 11, wherein the plug housing includes a bottom part, which has openings in a number corresponding to the number of plug pins.

15. The plastic housing of claim 14, wherein in the process of joining, the openings of the plug housing are deformed by the plug pins so that the material of the plug housing forms a seal on the at least one plug pin.

16. The plastic housing of claim 11, wherein one of a peripheral collar and a stop face, which limits a depth of immersion of a bottom part into the receptacle opening, is formed on a lateral surface of the plug housing.

17. The plastic housing of claim 11, wherein the plug housing and the plastic housing are connected to each other by a material connection along a border.

18. A method for manufacturing a plastic housing having an integrated plug interface, the method comprising:
a) manufacturing a plug housing, which forms a plug interface in an injection mold with high dimensional stability requirements;
b) manufacturing a plastic housing in a separate injection mold; and
c) joining the plug housing in a receptacle opening of the plastic housing and subsequent creation of a material connection between the plug housing and the plastic housing.

19. The method of claim 18, wherein a press fit is created between a bottom part and the border of the receptacle opening in the joining of c).

20. The method of claim 18, wherein according to the joining of c), the material connection between the plug housing and the border is created by one of laser welding and adhesive bonding.
